(19) United States
(12) Patent Application Publication
(10) Pub. No.: US 2016/0215682 A1
(43) Pub. Date: Jul. 28, 2016

(54) IGNITION SYSTEM UTILIZING CONTROLLABLY VENTED PRE-CHAMBER

(71) Applicant: Caterpillar Inc., Peoria, IL (US)

(72) Inventors: Joel David Hiltner, Bellingham, WA (US); Martin Leo Willi, Dunlap, IL (US)

(73) Assignee: Caterpillar Inc., Peoria, IL (US)

(21) Appl. No.: 14/602,605

(22) Filed: Jan. 22, 2015

(51) Int. Cl. F02B 19/02; F02B 19/12; F02D 41/30; F02B 19/10

(52) U.S. Cl. CPC F02B 19/02; F02B 19/1071; F02B 19/12; F02D 41/3041; F02D 41/3035

(57) ABSTRACT

An ignition system is disclosed for use with an engine having a combustion chamber. The ignition system may have a pre-chamber configured to fluidly communicate with the combustion chamber of the engine, and a vent passage open to the pre-chamber. The ignition system may also have a valve configured to selectively allow fluid flow through the vent passage.

### TECHNICAL FIELD

The present disclosure relates generally to an ignition system and, more particularly, to an ignition system utilizing a controllably vented pre-chamber.

### BACKGROUND

Engines, including diesel engines, gasoline engines, gaseous fuel powered engines, and other engines known in the art ignite or admit an air/fuel mixture to produce heat. Fuel directed into a combustion chamber of the engine can be ignited by way of a spark plug, a glow plug, or an AC/DC ignition source. The heat and expanding gases resulting from this combustion process are directed to displace a piston or move a turbine blade, both of which can be connected to a crankshaft of the engine. As the piston is displaced or the turbine blade is moved, the crankshaft is caused to rotate. This rotation is utilized to directly an output drive a device such as a transmission or a generator to propel a vehicle or to produce electrical power.

It has been established that a well-distributed flame inside the combustion chamber of an engine promotes improved combustion of the air/fuel mixture. Improved combustion can be manifest in a reduction in air pollution and fuel consumption. One way to produce a well-distributed combustion flame is through the use of a pre-chamber. The pre-chamber can form a portion of the engine or, alternatively, a portion of the ignition source (e.g., a portion of the spark plug).

Although the use of a pre-chamber may provide certain performance improvements, there may also be drawbacks. In particular, circulation of fluids through the pre-chamber can be unreliable, causing high-temperature residual gases from a preceding combustion cycle to remain inside the pre-chamber. These residual gases can inhibit fresh air and fuel from entering the pre-chamber in preparation for the next cycle. When this happens, combustion during the next cycle may not initiate properly. In addition, the high-temperature residual gases can cause structural damage to the ignition source if not adequately controlled.

One attempt at improving operation of an engine having a pre-chamber ignition source is disclosed in U.S. Pat.. No. 7,849,830 (the '830 patent) that issued to Maul et al. on Dec. 14, 2010. In particular, the '830 patent discloses a spark plug having an ignition electrode disposed within a pre-chamber, and a supply line connected to the electrode. A pipe housing encloses the supply line, and a venting channel is provided for continuously discharging combustion gases to the atmosphere that have leaked into the pipe housing.

Although the spark plug of the '830 patent may have a lower pressure inside the pipe housing due to the venting channel, it may still be problematic. In particular, the venting channel may not be able to scavenge the pre-chamber.

The disclosed ignition control system is directed to overcoming one or more of the problems set forth above and/or other problems of the prior art.

### SUMMARY

In one aspect, the present disclosure is directed to an ignition system for an engine having a combustion chamber. The ignition system may include a pre-chamber configured to fluidly communicate with the combustion chamber of the engine, and a vent passage open to the pre-chamber. The ignition system may also include a valve configured to selectively allow fluid flow through the vent passage.

In another aspect, the present disclosure is directed to another ignition system for an engine having a combustion chamber and an induction system in fluid communication with the combustion chamber. This ignition system may include a spark plug having a pre-chamber configured to fluidly communicate with the combustion chamber of the engine, and a vent passage configured to extend from the pre-chamber of the spark plug to the induction system of the engine. The ignition system may also include a valve configured to selectively allow fluid flow through the vent passage, and a controller configured to regulate operation of the valve.

In yet another aspect, the present disclosure is directed to a method of initiating combustion within a combustion chamber of an engine. The method may include generating a spark inside a pre-chamber to ignite an air/fuel mixture, and directing a flame jet from the pre-chamber into the combustion chamber. The method may further include selectively venting the pre-chamber.

### BRIEF DESCRIPTION OF THE DRAWINGS

FIG. 1 is a diagrammatic illustration of an exemplary disclosed engine; and

FIG. 2 is diagrammatic and schematic illustration of an exemplary disclosed ignition system that may be used in conjunction with the engine of FIG. 1.

### DETAILED DESCRIPTION

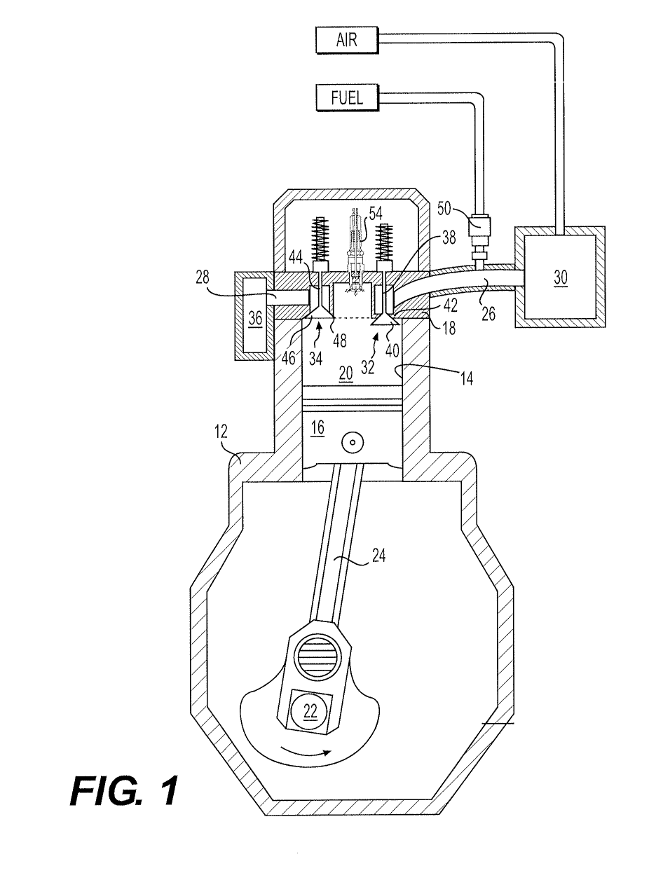

FIG. 1 illustrates an exemplary combustion engine 10. For the purposes of this disclosure, engine 10 is depicted and described as a four-stroke gaseous-fueled engine, for example a natural gas engine. One skilled in the art will recognize, however, that engine 10 may be any other type of combustion engine such as, for example, a gasoline-fueled engine or a dual-fuel (e.g., a natural gas and diesel-fueled) engine. Engine 10 may include an engine block 12 that at least partially defines one or more cylinders 14 (only one shown in FIG. 1). A piston 16 may be slidably disposed within each cylinder 14 to reciprocate between a top-dead-center (TDC) position and a bottom-dead-center (BDC) position, and a cylinder head 18 may be associated with each cylinder 14. Cylinder 14, piston 16, and cylinder head 18 may together define a combustion chamber 20. It is contemplated that engine 10 may include any number of combustion chambers 20 and that combustion chambers 20 may be disposed in an “in-line” configuration, in a “V” configuration, in an “opposing piston” configuration, or in any other suitable configuration.

Engine 10 may also include a crankshaft 22 that is rotatably disposed within engine block 12. A connecting rod 24 may connect each piston 16 to crankshaft 22 so that a sliding motion of piston 16 between the TDC and BDC positions within each respective cylinder 14 results in a rotation of crankshaft 22. Similarly, a rotation of crankshaft 22 may result in a sliding motion of piston 16 between the TDC and BDC positions. In a four-stroke engine, piston 16 may reciprocate between the TDC and BDC positions through an intake stroke, a compression stroke, a combustion or power stroke, and an exhaust stroke. It is also contemplated that engine 10 may alternatively be a two-stroke engine, wherein a complete cycle includes a compression/exhaust stroke (BDC to TDC) and a power/exhaust/intake stroke (TDC to BDC).

Cylinder head 18 may define an intake passageway 26 and an exhaust passageway 28. Intake passageway 26 may direct compressed air or an air/fuel mixture from an intake manifold 30, through an intake opening 32, and into combustion chamber 20. Exhaust passageway 28 may similarly direct exhaust gases from combustion chamber 20, through an exhaust opening 34, and into an exhaust manifold 36. In some embodiments, a turbocharger (not shown) may be driven by the exhaust exiting manifold 36 to compress the air entering manifold 30.

An intake valve 38 having a valve element 40 may be disposed within intake opening 32 and configured to selectively engage a seat 42. Intake valve 38 may be movable between a first position, at which valve element 40 engages seat 42 to inhibit a flow of fluid relative to intake opening 32, and a second position, at which valve element 40 is removed from seat 42 to allow the flow of fluid.

An exhaust valve 44 having a valve element 46 may be similarly disposed within exhaust opening 34 and configured to selectively engage a seat 48. Valve element 46 may be movable between a first position, at which valve element 46 engages seat 48 to inhibit a flow of fluid relative to exhaust opening 34, and a second position, at which valve element 46 is removed from seat 48 to allow the flow of fluid.

A series of valve actuation assemblies (not shown) may be operatively associated with engine 10 to move valve elements 40 and 46 between the first and second positions. It should be noted that each cylinder head 18 could include multiple intake openings 32 and multiple exhaust openings 34. Each such opening would be associated with either an intake valve element 40 or an exhaust valve element 46. Engine 10 may include a valve actuation assembly for each cylinder head 18 that is configured to actuate all of the intake valves 38 or all of the exhaust valves 44 of that cylinder head 18. It is also contemplated that a single valve actuation assembly could actuate the intake valves 38 or the exhaust valves 44 associated with multiple cylinder heads 18, if desired. The valve actuation assemblies may embody, for example, a cam/push-rod/rocker arm arrangement, a solenoid actuator, a hydraulic actuator, or any other means for actuating known in the art.

A fuel admittance device 50 may be associated with engine 10 to direct pressurized fuel into combustion chamber 20. Fuel admittance device 50 may embody, for example, an electronic valve situated in communication with intake passageway 26. It is contemplated that admittance device 50 could alternatively embody a hydraulically, mechanically, or pneumatically actuated device that selectively pressurizes and/or allows pressurized fuel to pass into combustion chamber 20 via intake passageway 26 or in another manner (e.g., directly). The fuel may include a compressed gaseous fuel such as, for example, natural gas, propane, bio-gas, landfill gas, or hydrogen. It is also contemplated that the fuel may be liquefied, for example, gasoline, diesel, methanol, ethanol, or any other liquid fuel may be injected into combustion chamber 20, and that an onboard pump (not shown) may be required to pressurize the fuel.

The amount of fuel allowed into intake passageway 26 by admittance device 50 may be associated with a ratio of air-to-fuel introduced into combustion chamber 20. Specifically, if it is desired to introduce a lean mixture of air and fuel (mixture having a relatively low amount of fuel compared to the amount of air) into combustion chamber 20, admittance device 50 may remain in an injecting position for a shorter period of time (or otherwise be controlled to inject less fuel per given cycle) than if a rich mixture of fuel and air (mixture having a relatively large amount of fuel compared to the amount of air) is desired. Likewise, if a rich mixture of air and fuel is desired, admittance device 50 may remain in the injecting position for a longer period of time (or otherwise be controlled to inject more fuel per given cycle) than if a lean mixture is desired. A lean mixture of air and fuel may be generally more difficult to ignite, but also burns at a lower temperature and produces less regulated emissions.

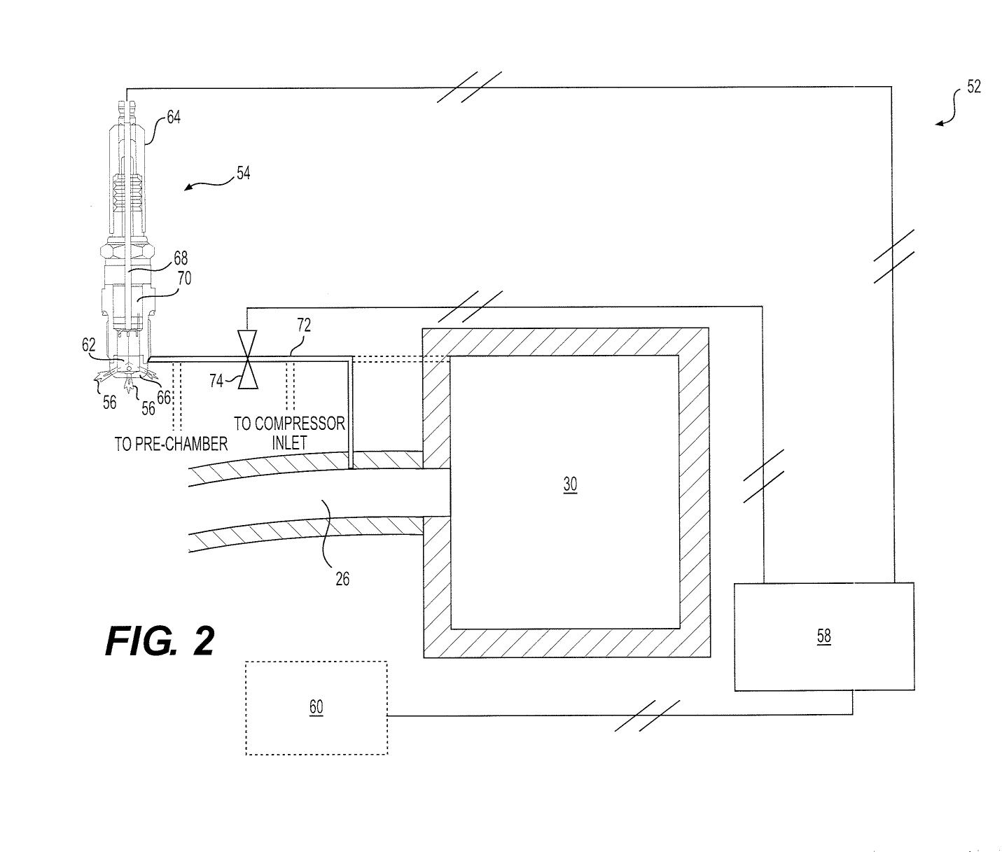

As shown in FIG. 2, an ignition system 52 may be associated with engine 10 to help regulate the combustion of the fuel and air mixture within combustion chamber 20. Ignition system 52 may include one or more igniters 54 (shown in FIGS. 1 and 2) associated with each combustion chamber 20, and an electronic control unit (ECU) 58 in communication with igniters 54. ECU 58 may be configured to regulate operation of igniters 54 in response to input received from one or more sensors 60.

Each igniter 54 may be configured to facilitate ignition of the air/fuel mixture within the corresponding combustion chamber 20. Specifically, the mixture of air and fuel may be ignited by a flame jet 56 propagating into the combustion chamber 20 as the associated piston 16 nears TDC during the compression stroke, as piston 16 leaves TDC during the power stroke, or at another appropriate time. Flame jet 56 may be generated by igniter 54 through the use of a pre-chamber 62.

In one embodiment, pre-chamber 62 may be an integral part of igniter 54. In particular, igniter 54 may include a body 64, a cap 66, and one or more electrodes 68. Cap 66 may be generally hollow and perforated, and together with body 64 at least partially define an integral pre-combustion chamber (also known as pre-chamber 62). Electrode(s) 68 may extend from a terminal end of igniter 54 through body 64 and at least partially into pre-chamber 62. In some applications, an insulator 70 may be disposed between body 64 and electrode(s) 68 to electrically isolate electrode(s) 68 from body 64.

Body 64 may be a generally cylindrical structure fabricated from an electrically conductive material. In one embodiment, body 64 may include external threads configured for direct engagement with engine block 12 or cylinder head 18. In this configuration, body 64 may be electrically grounded via the threaded connection.

Cap 66 may have a cup-like shape and be fixedly connected to a base end of body 64. Cap 66 may be welded, press-fitted, threadingly engaged, or otherwise fixedly connected to body 64. Cap 66 may include one or more orifices that facilitate the flow of air and fuel into pre-chamber 62, as well as the passage of flame jets 56 from pre-chamber 62 into combustion chamber 20. The orifices may pass generally radially through an annular side- and/or end-wall of cap 66 in a distributed manner.

Electrode(s) 68 may be fabricated from an electrically conductive metal such as, for example, tungsten, iridium, silver, platinum, and gold palladium, and be configured to direct current from a power supply (not shown) to ionize (i.e., create a corona within) the air and fuel mixture of pre-chamber 62 that ignites the air and fuel mixture. In one embodiment, a plurality of prongs (not shown) may extend generally radially toward an internal wall of pre-chamber 62.

In another embodiment, pre-chamber 62 may be separate from igniter 54. Specifically, pre-chamber 62 may be a chamber built into cylinder head 18 and/or engine block 12 that is separate from but in fluid communication with combustion chamber 20. In this embodiment, igniter 54 may extend into pre-chamber 62 and be used to ignite the fuel air mixture in pre-chamber 62. Once the mixture is ignited inside pre-chamber 62, just as in the first embodiment, flame jets 56 may shoot out into combustion chamber 20 via orifices in a plate separating pre-chamber 62 from combustion chamber 20.

In yet another embodiment, two pre-chambers 62 may be utilized. For example, igniter 54 may be a pre-chamber type of spark plug having its own integral pre-chamber, while also extending a distance into a pre-chamber 62 that is built into engine block 12 and/or cylinder head 18. Other configurations may also be possible.

ECU 58 may be used to regulate the timing of corona discharge by igniter 54 into pre-chamber 62 and, thereby, the propagation of flame jets 56 into combustion chamber 20 and the subsequent initiation of the main combustion event. ECU 58 may embody a single or multiple microprocessor controllers, field programmable gate arrays (FPGAs), digital signal processors (DSPs), etc., that include a means for controlling an operation of engine 10 in response to signals received from sensor 60. Numerous commercially available controllers can be configured to perform the functions of ECU 58. It should be appreciated that ECU 58 could readily embody a general engine microprocessor capable of controlling numerous system functions and modes of operation. Various other known circuits may be associated with ECU 58, including power supply circuitry, signal-conditioning circuitry, actuator driver circuitry (i.e., circuitry powering solenoids, motors, or piezo actuators), communication circuitry, and other appropriate circuitry.

Sensor 60 may be configured to generate a signal indicative of an engine performance parameter. For example, sensor 60 may be disposed proximal to crankshaft 22 (referring to FIG. 1) and configured to measure and generate a signal indicative of an instantaneous angular position of crankshaft 22 and a corresponding position of piston 16 relative to its TDC and BDC positions of its various strokes. Based on this position, a timing may be determined by ECU 58 at which igniter 54 should be energized to provide a desired performance (e.g., power, emissions, fuel efficiency, etc.) of engine 10. It should be noted that other similar sensors are also contemplated for use by ECU 58 in controlling igniter 54.

In order for igniter 54 to reliably generate flame jets 56, a sufficient amount of fresh air and fuel must present within pre-chamber 62 at the time that ECU 58 causes igniter 54 to discharge. This may be accomplished by selectively venting or scavenging pre-chamber 62 to remove residual gases from a previous combustion cycle and to also draw in the fresh air and fuel. In addition to providing the right mixture for combustion, this circulation of relatively colder fluids through pre-chamber 62 may also function to cool pre-chamber 62. For this purpose, a vent passage 72 may be provided that is in communication with pre-chamber 62 (e.g., with either the pre-chamber integral with igniter 54 or the pre-chamber built into engine 10), and a valve 74 may be disposed within vent passage 72. ECU 58 may be configured to selectively cause valve 74 to open and close at appropriate timings to allow pressurized residual gases to discharge from pre-chamber 62 through vent passage 72.

The residual gases flowing through vent passage 72 may be discharged into any one of multiple locations within an induction system of engine 10. For example, vent passage 72 may extend from pre-chamber 62 to the associated intake passage 26. Additionally or alternatively, vent passage 72 could extend to intake manifold 30 or to a location upstream of any associated turbocharger (i.e., upstream of the compressor section of the turbocharger). Alternatively, vent passage 72 could extend to the atmosphere or to exhaust passage 28 and/or manifold 36.

Valve 74 may be any type of valve known in the art that can close against the high pressures typically present within combustion chamber 20, when necessary, and that also allows fluid flow in only one direction (e.g., out of pre-chamber 62). In one example, valve 74 is a solenoid-operated check valve that is spring-biased to one position (e.g., to the closed position) and that opens when energized by ECU 58. In another example, valve 74 may be similar to valves 32 and 34 (referring to FIG. 1) and mechanically opened by way of a cam lobe. In yet another example, valve 74 may be opened by an imbalance of fluid pressures created by progress of the combustion cycle. Any combination of these and other types of valves may be utilized.

It is contemplated that passage 72 and/or valve 74 may be formed/disposed partially or entirely within igniter 54. For example, vent passage 72 may be formed as an axially oriented capillary positioned within body 64 (e.g., within insulator 70), and valve 74 may be mounted to igniter 54 at an end opposite pre-chamber 62. During installation of igniter 54, a conduit may be connected to the capillary and to the induction system of engine 10 to form a remaining portion of vent passage 72. With this configuration, existing engines with or without a built-in pre-chamber may benefit from the scavenging provided by the disclosed ignition system. In particular, engines having a built-in pre-chamber may have the pre-chamber scavenged by way of the integral igniter pre-chamber.

In other embodiments, passage 72 and/or valve 74 may be formed/disposed partially or entirely within engine 10. For example, vent passage 72 may be drilled as a radial passage inside cylinder head 18, and valve 74 may be threaded into a corresponding bore in cylinder head 18. In this configuration, a built-in pre-chamber may be more easily scavenged as the flow would not need to pass through a capillary passage in igniter 54.

Scavenging of pre-chamber 62 may be timed to coincide with particular strokes of piston 16, such that corresponding pressures inside combustion chamber 20 may enhance the scavenging process. For example, valve 74 may be caused to open and pass residual gases to the induction system during a portion of the compression stroke of piston 16 when pressures inside combustion chamber 20 are high. In one embodiment, valve 74 may open for a duration of about 20-90° of crank angle during the compression stroke. Valve 74 may then be caused to close during the same compression stroke or, alternatively, at a start of the ensuing power stroke.

### INDUSTRIAL APPLICABILITY

The disclosed ignition system may be applicable to any combustion engine where precise control over combustion initiation is desired. Although particularly suited for use with lean-burn engines where combustion initiation can be difficult due to the low amount of available fuel, the disclosed ignition system may be used with any combustion engine during any type of operation. The disclosed ignition system may improve combustion initiation by ensuring that residual gases are scavenged from the area of spark ignition (i.e., from the pre-chamber) and that a sufficient supply of fresh air and fuel is provided at the time of spark initiation.

It will be apparent to those skilled in the art that various modifications and variations can be made to the disclosed ignition system. Other embodiments will be apparent to those skilled in the art from consideration of the specification and practice of the disclosed ignition system. For example, while valve 74 is described as being open during a compression stroke so as to scavenge pre-chamber 62, it may also be possible to open valve 74 during an intake stroke, if vent passage 72 were connected downstream of the turbocharger compression section. In this embodiment, high pressure flow could be reversed through vent passage 72 to push out residual gases. It is intended that the specification and examples be considered as exemplary only, with a true scope being indicated by the following claims and their equivalents.

What is claimed is:

1. An ignition system for an engine having a combustion chamber, comprising:
a pre-chamber configured to fluidly communicate with the combustion chamber of the engine;
a vent passage open to the pre-chamber; and
a valve configured to selectively allow fluid flow through the vent passage.

2. The ignition system of claim 1, further including a spark plug operatively connected to the engine, wherein the pre-chamber forms a portion of the spark plug.

3. The ignition system of claim 1, further including a spark plug operatively connected to the engine and configured to extend at least partially into the pre-chamber, wherein the pre-chamber forms a portion of the engine.

4. The ignition system of claim 1, wherein:
the engine includes an induction system; and
the vent passage is configured to extend from the pre-chamber to the induction system.

5. The ignition system of claim 4, wherein:
the induction system includes an inlet manifold and an inlet passage extending from the inlet manifold to the combustion chamber; and
the vent passage is configured to extend to the inlet manifold.

6. The ignition system of claim 4, wherein:
the induction system includes an inlet manifold and a turbocharger in fluid communication with the inlet manifold; and
the vent passage is configured to extend to a location upstream of a compressor section of the turbocharger.

7. The ignition system of claim 1, further including a controller configured to regulate operation of the valve.

8. The ignition system of claim 7, further including a sensor configured to generate a signal indicative of an operating parameter of the engine, wherein the controller is configured to selectively effect operation of the valve based on the signal.

9. The ignition system of claim 8, wherein:
the signal is indicative of a crank angle of the engine; and
the controller is configured to cause the valve to open and allow fluid flow through the vent passage during a portion of a compression stroke of the engine.

10. The ignition system of claim 9, wherein:
the signal is indicative of a crank angle of the engine; and
the controller is configured to cause the valve to close and inhibit fluid flow through the vent passage during a portion of a combustion stroke of the engine.

11. The ignition system of claim 8, wherein the controller is configured to cause the valve to open and allow fluid flow through the vent passage for a duration of about 20-90° of crank angle.

12. An ignition system for an engine having a combustion chamber and an induction system in fluid communication with the combustion chamber, the ignition system comprising:
a spark plug having a pre-chamber configured to fluidly communicate with the combustion chamber of the engine;
a vent passage configured to extend from the pre-chamber of the spark plug to the induction system of the engine;
a valve configured to selectively allow fluid flow through the vent passage; and
a controller configured to regulate operation of the valve.

13. The ignition system of claim 12, further including a sensor configured to generate a signal indicative of a crank angle of the engine, wherein the controller is configured to selectively cause the valve to open during a portion of a portion of at least one of the compression and intake strokes of the engine.

14. A method of initiating combustion within a combustion chamber of an engine, comprising:
generating a spark inside a pre-chamber to ignite an air/fuel mixture;
directing a flame jet from the pre-chamber into the combustion chamber; and
selectively venting the pre-chamber.

15. The method of claim 14, wherein selectively venting the pre-chamber includes selectively allowing fluid to flow from the pre-chamber to an induction system of the engine.

16. The method of claim 15, wherein:
the induction system includes an inlet manifold and an inlet passage extending from the inlet manifold to the combustion chamber; and
selectively venting the pre-chamber includes selectively allowing fluid to flow from the pre-chamber to the inlet manifold.

17. The method of claim 15, wherein:
the induction system includes a turbocharger; and
selectively venting the pre-chamber includes selectively allowing fluid to flow from the pre-chamber to a location upstream of a compressor section of the turbocharger.

18. The method of claim 14, further including sensing an operating parameter of the engine, wherein selectively venting the pre-chamber includes selectively venting the pre-chamber based on the operating parameter.

19. The method of claim 18, wherein:
the operating parameter is a crank angle of the engine; and
selectively venting the pre-chamber includes selectively venting the pre-chamber during a portion of a compression stroke of the engine.

20. The method of claim 18, wherein:
the operating parameter is a crank angle of the engine; and
selectively venting the pre-chamber includes selectively venting the pre-chamber for a duration of about 20-90° of crank angle.
